(19) United States
(12) Patent Application Publication
(10) Pub. No.: US 2025/0391584 A1
(43) Pub. Date: Dec. 25, 2025

(54) Pigtail Assembly and Installation Methods

(71) Applicant: NSI-Lynn Electronics, LLC, Huntersville, NC (US)

(72) Inventors: Charles Hoskins, Miamisburg, OH (US); James Farrell, Elyria, OH (US)

(73) Assignee: NSI-Lynn Electronics, LLC, Huntersville, NC (US)

(21) Appl. No.: 19/242,344

(22) Filed: Jun. 18, 2025

Related U.S. Application Data
(60) Provisional application No. 63/662,093, filed on Jun. 20, 2024.

(51) Int. Cl. H01B 7/00; G02B 6/44; H01B 7/36

(52) U.S. Cl. CPC H01B 7/0045; G02B 6/443; H01B 7/361

(57) ABSTRACT

Disclosed is a wire assembly that includes, in certain embodiments, a plurality of wires each extending from a first end to a second end, the first end of each wire being terminated by a connector. The wire assembly also includes a cable jacket and a casing. The cable jacket bundles the plurality of wires over a first region of the assembly which is positioned between the first end and the second end of the plurality of wires. The casing is coupled to the cable jacket and disposed around a second region of the assembly which is positioned proximate the second end of the plurality of wires. The casing is at least partially removable by hand so as to expose a segment of at least one of the plurality of wires.

### CROSS-REFERENCE TO RELATED APPLICATIONS

This application claims the benefit of a co-pending, commonly assigned U.S. Provisional Patent Application No. 63,662,093, which was filed on Jun. 20, 2024. The entire content of the foregoing provisional application is incorporated herein by reference.

### BACKGROUND

In the field of network and low voltage cables, e.g., fiber optic, coaxial, and twisted pair cables, the cables are often bundled together in so called “pigtails.” Multiple individual cables, having terminated connection ends, are bundled together with a buffer material inside a common cable jacket. The connections ends are hooked up to hub and an electrician or other user strips the buffer material and hytrel tube/jacket as desired to access the individual bare wires housed therein. The individual bare wires are then separated out and hooked up as needed during installation. Depending on the length of the cable, the number of wires in the bundle, and how much of the buffer and tubular jacket needs to be stripped from each wire, the installation and stripping process can be tedious and time consuming.

### SUMMARY

According to some embodiments of the present disclosure, a wire assembly is provided. The wire assembly includes, inter alia, a plurality of wires each extending from a first end to a second end, the first end of each wire being terminated by a connector. The wire assembly also includes a cable jacket and a casing. The cable jacket bundles the plurality of wires over a first region of the assembly which is positioned between the first end and the second end of the plurality of wires. The casing is coupled to the cable jacket and disposed around a second region of the assembly which is positioned proximate the second end of the plurality of wires. The casing is at least partially removable by hand so as to expose a segment of at least one of the plurality of wires.

Preferably, the assembly includes a third region which is positioned proximate the first end and the cable jacket is terminated such that the plurality of wires are unbundled and are not surrounded by the cable jacket in the third region.

In an embodiment, each of the plurality of wires includes a wire jacket which extends over at least the first and third regions of the assembly. Preferably, the wire jacket of each of the plurality of wires terminates prior to the second end such that a portion of each of the plurality of wires is bare over the second region.

In certain constructions of the present disclosure, the wire assembly further includes a fan out kit coupled to the cable jacket and the plurality of wires are disposed in the fan out kit, wherein the fan out kit separates each of the plurality of wires from each other.

It is envision that the casing can be made of a plurality of subsections and each subsection is individually removable. Alternatively, the casing can be formed as a spiral structure. It is presently preferred that the casing is flexible to allow the assembly to bend along a central axis. Additionally, at least one aperture can be formed along the length of the casing to allow a portion of at least one of the plurality of wires to be removed from withing the casing.

The present disclosure is also directed to a wire assembly that includes, inter alia, a plurality of wires, a cable jacket and a casing. The plurality of wires each extending from a first end to a second end, the first end of each wire being terminated by a connector. Each of the plurality of wires includes a wire jacket which extends over a first segment of the wire leaving a bare second segment. The cable jacket bundles the plurality of wires over a first region of the assembly which is positioned between the first end and the second end of the plurality of wires. The casing is coupled to the cable jacket and disposed around a second region of the assembly which is positioned proximate the second end of the plurality of wires. The casing is at least partially removable by hand so as to expose the bare second segment of at least one of the plurality of wires.

Preferably, the assembly includes a third region which is positioned proximate the first end and the cable jacket is terminated such that the plurality of wires are unbundled and are not surrounded by the cable jacket in the third region.

In certain constructions of the present disclosure, the wire assembly further includes a fan out kit coupled to the cable jacket and the plurality of wires are disposed in the fan out kit, wherein the fan out kit separates each of the plurality of wires from each other.

It is envision that the casing can be made of a plurality of subsections and each subsection is individually removable. Alternatively, the casing can be formed as a spiral structure. It is presently preferred that the casing is flexible to allow the assembly to bend along a central axis. Additionally, at least one aperture can be formed along the length of the casing to allow a portion of at least one of the plurality of wires to be removed from withing the casing.

### BRIEF DESCRIPTION OF DRAWINGS

The subject matter, which is regarded as the disclosure, is particularly pointed out in the specification. The foregoing and other features, and advantages of the disclosure are apparent from the following detailed description taken in conjunction with the accompanying drawings in which like reference numerals refer to like elements throughout the different views:

FIG. 1 is a schematic view of a pigtail wire assembly which has been constructed in accordance with an embodiment of the present disclosure;

FIG. 2 is an image of a bundled wire assembly with a quick remove casing;

FIG. 3 is an image of a pigtail wire assembly connected to a wire hub;

FIG. 4 is a close up of the coiled pigtail wire assembly of FIG. 3; and

FIG. 5 is a schematic view of the casing of the pigtail wire assembly.

### DETAILED DESCRIPTION

The subject matter disclosed herein relates to pigtail wire assemblies. More specifically, the present disclosure relates to a an easy to remove spiral casing which houses the plurality of individual wires in a pigtail wire assembly to facilitate installation.

In some embodiments, the disclosed pigtail assembly includes a plurality of individual wires. A first portion of the plurality of wires are bundled together in a spiral casing that is removably connected at one end to a cable jacket and the cable jacket is connected at its other end to a fan out kit. A second portion of the plurality of wires passes through the fan out kit and are separated out into individual wires, each wire being terminated by a connector. The spiral casing is removed to expose a section of the plurality of wires which does not include a hytrel tube/jacket for use, for example by an electrician for installation.

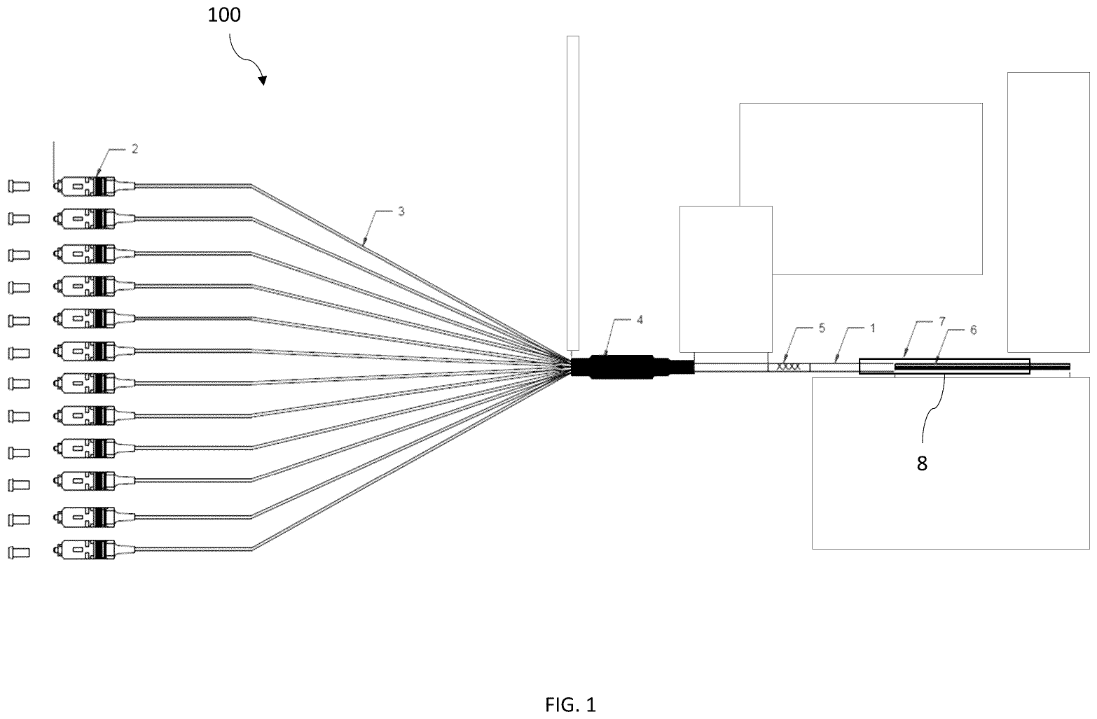

Referring now to FIG. 1, shown is a pigtail wire assembly 100 according to some embodiments of the present disclosure. The pig tail assembly 100 includes twelve wires 3 each being surrounded by a hytrel tube/wire jacket along a substantial portion of their length and being terminated by a connector 2. The individual wire jackets can be color coded. The wires 3 may be a copper, fiber optic, coaxial or other type of electrical or data transfer cable. The connectors 2 may be any American Power Conversion (APC) connector, Ultra-Physical Contact (UPC) connector, or other wire termination connector styles. FIG. 1 illustrates an SC type simplex connector. Each of the wires 3 are disposed predominantly in a cable jacket 1 over a first region of the assembly. The cable jacket can also can be color coded. A first end portion of the wires 3 is fed into a fan out kit 4 which fans out the connectorized ends of the wires 3. In the embodiment shown in FIG. 1, the cable jacket 1 contains twelve wires 3, however those skilled in the art will readily appreciate that more or less wires 3 may be bundled as desired for particular application or wiring standard.

The cable jacket extends out from the fan out kit 4. The individual wires 3 may be wrapped in a buffer 7 and enclosed in cable jacket 1. The buffer 7 may be yarn, for example aramid yarn, armor, for example spiral steel or Kevlar armor, or another material to protect the bundle of bare wires 6. The cable jacket 1 may be any standard cable jacket, for example plastic or rubber. In some embodiments, the buffer 7 is removed and the bundle of bare wires 6 is housed in the cable jacket 1 alone. Removing the buffer 7 may be desirable to reduce the diameter of the pigtail wire assembly 100 for installation in compact spaces.

A casing 8 is attached to an end of the cable jacket 1. The casing 8 wraps around the bare wires 6 over a second region for the assembly to protect the fiber optics and to keep the bare wires 6 from separating and becoming tangled. In some embodiments, the casing 8 is attached to the cable jacket 1 by tape, glue, or another removable adhesive. The casing 8 may extend from the cable jacket 1 to the end point of the bundle of bare wires 6. The casing 8 may be spiral cut or have spiral indentations or perforations to facilitate unwrapping and removing the casing 8, thereby exposing the bundle of bare wires 6 in a piecemeal fashion. In this way, the bundle of bare wires 6 can be exposed providing access to the wires for installation as desired. For example, the connector 2 may be hooked up to a wire hub with the pigtail wire assembly 100, including at least the bundle of bare wires 6 housed in the cable jacket 1 and the casing 8, being installed though the walls of a house. The casing 8 is then stripped away or unraveled at select locations where wires of the bundle of bare wires 6 are needed to be installed without having to strip the cable jacket 1 along the entire length of the pigtail wire assembly 100.

In some embodiments, a code/label 5 is printed on the cable jacket 1 to identify the pigtail wire assembly 100 and contain information about the pigtail wire assembly 100, for example the wire type, number of wires, the connector type, etc. The code/label 5 may be a QR code, a bar code, an alpha numeric string, or another identifier which can be used to differentiate an individual pigtail wire assembly 100 or a class of pigtail wire assemblies 100.

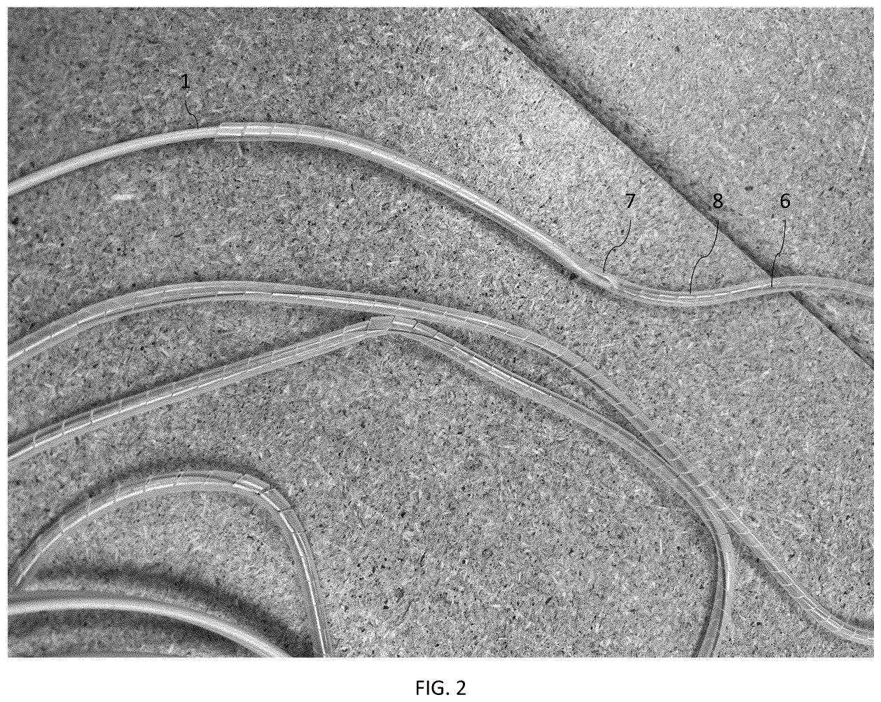

Referring now to FIG. 2, shown is an image of the bundle of bare wires 6 inside the cable jacket 1 and the casing 8 according to some embodiments of the present disclosure. The casing 8 may partially overlap the cable jacket 1 and be attached to the cable jacket 1 at an intermediary position along the length of the cable jacket 1. The casing may be made from a material such as silicon and be at least partially opaque or clear. As shown, the casing 8 may be spiral cut. In this way the casing 8 may be bent as necessary to facilitate installation in compact spaces and around corners. The casing 8 may also be unraveled in stepwise fashion to expose portions of the bundle of bare wires 6 as desired. In some embodiments, the casing 8 is loosely wrapped around the bundle of bare wires 6 to facilitate removal of the casing 8.

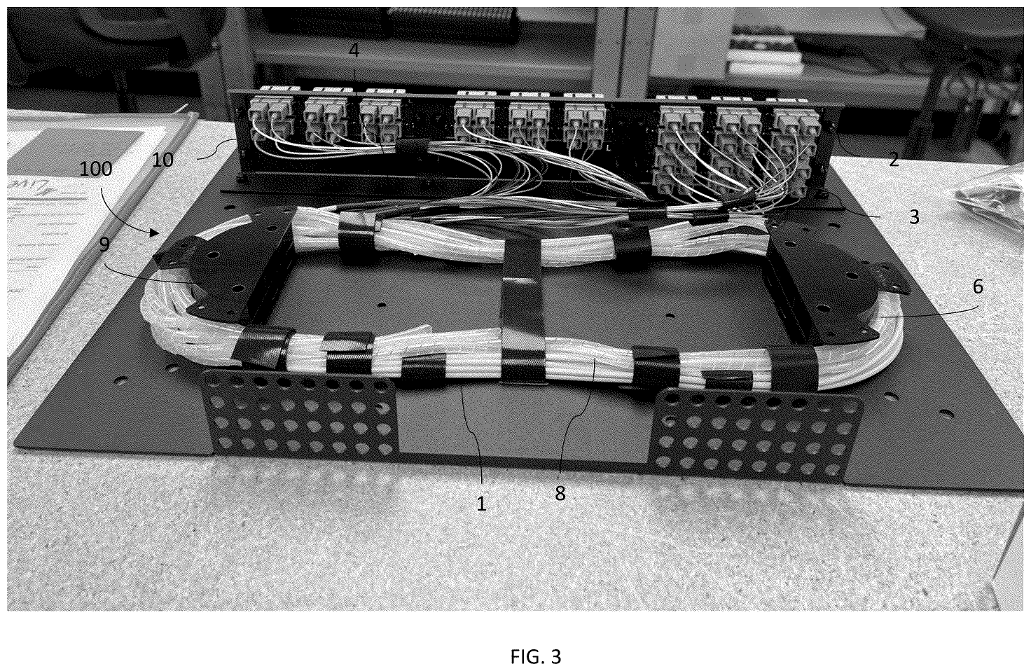

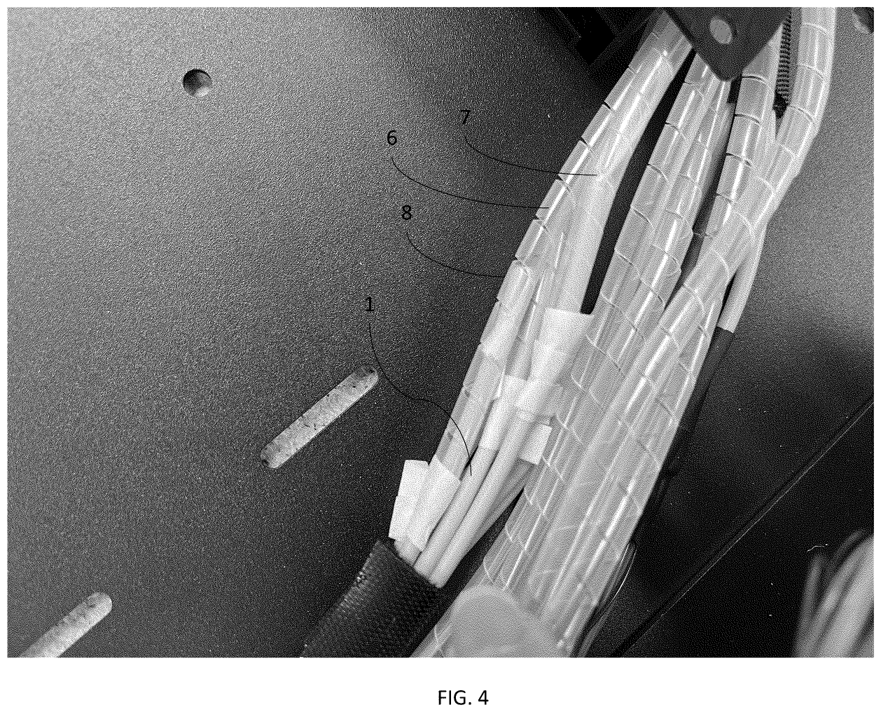

Referring now to FIGS. 3 and 4, shown are multiple pigtail wire assemblies 100 in a splice tray 9 connected to a connection hub 10 according to some embodiments of the present disclosure. As shown, one or more pigtail wire assemblies 100 may be wrapped around a splice tray 9 with the respective connectors 2 hooked up to a connection hub 10. The pigtail wire assemblies 100 may be secured to the splice tray 9 for ease of transport, for example using Velcro. Each of the wires 3 extend from a fan out kit 4 of the respective pigtail wire assembly 100 to a connector 2 engaged with the connection hub 10. The cable jacket 1, housing the bundle of bare wires 6, extends from the fan out kit 4, opposite of wires 3, and wraps around the splice tray 9. At a certain point along the length of the pigtail wire assembly 100 the cable jacket 1 terminates and is superseded by the casing 8, housing the bundle of bare wires 6, and continuing to be wrapped around the splice tray 9.

In some embodiments, during installation, the pigtail wire assembly 100 is unwrapped from the splice tray 9. The bundle of bare wires 6, inside of the casing 8, are unwrapped and installed in a desired location. The casing 8 is removed from the bundle of bare wires 6 and one or more of the wires may be removed, stripped, and installed as desired. The remaining wires of the bundle of bare wires 6 may be maintained in the casing 8 or the casing 8 may be rewrapped around the bundle of bare wires 6. In this embodiment, the cable jacket 1 does not need to be stripped from the bare wires 6 during the installation, since the portion of the bundle of bare wires 6 that is to be installed are housed in the casing 8.

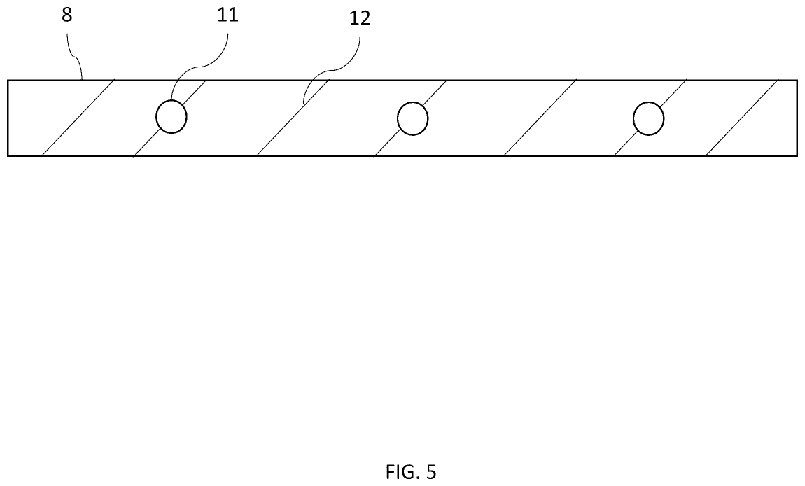

Referring now to FIG. 5, shown is the casing 8 of the pigtail wire assembly 100 according to some embodiments. The casing 8 may include one or more holes 11 along the length of the casing 8 as a means of egress for one or more wires of the bundle of bare wires 6. In some embodiments, the holes 11 may be located on the body of the casing 8 or may be located along the spiral cuts 12 of the casing 8 such that the holes 11 are bisected by the spiral cuts 12. During installation one or more wires of the bundle of bare wires 6 may be threaded through a hole 11 for installation without needing to fully unwrap the casing 8. Additionally, installing a wire through the hole 11 as opposed to through one of the spiral cuts 12 may prevent the wire from being pinched by the casing 8. For example, in the case of fiber optics, pinching or bending the fiber optic cable may reduce data transfer speeds.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A wire assembly comprising:
a plurality of wires each extending from a first end to a second end, the first end of each wire being terminated by a connector;
a cable jacket bundling the plurality of wires over a first region of the assembly which is positioned between the first end and the second end of the plurality of wires; and
a casing coupled to the cable jacket and disposed around a second region of the assembly which is positioned proximate the second end of the plurality of wires; and
wherein the casing is at least partially removable by hand so as to expose a segment of at least one of the plurality of wires.

2. The wire assembly of claim 1, wherein the assembly includes a third region which is positioned proximate the first end and the cable jacket is terminated such that the plurality of wires are unbundled and are not surrounded by the cable jacket in the third region.

3. The assembly of claim 2, wherein each of the plurality of wires includes a wire jacket which extends over at least the first and third regions of the assembly.

4. The assembly of claim 3, wherein the wire jacket of each of the plurality of wires terminates prior to the second end such that a portion of each of the plurality of wires is bare over the second region.

5. The assembly of claim 1, further comprising a fan out kit coupled to the cable jacket and the plurality of wires are disposed in the fan out kit, wherein the fan out kit separates each of the plurality of wires from each other.

6. The assembly of claim 1, wherein the casing is made of a plurality of subsections and each subsection is individually removable.

7. The assembly of claim 1, wherein each of the plurality of wires is color coded.

8. The assembly of claim 1, wherein the casing is formed as a spiral structure.

9. The assembly of claim 1, wherein the casing is flexible to allow the assembly to bend along a central axis.

10. The assembly of claim 1, wherein at least one aperture is formed along the length of the casing to allow a portion of at least one of the plurality of wires to be removed from withing the casing.

11. The assembly of claim 1, wherein the casing is secured to the cable jacket using adhesive.

12. The assembly of claim 1, wherein the casing is made from silicon.

13. A wire assembly comprising:
a plurality of wires each extending from a first end to a second end, the first end of each wire being terminated by a connector; wherein each of the plurality of wires includes a wire jacket which extends over a first segment of the wire leaving a bare second segment;
a cable jacket bundling the plurality of wires over a first region of the assembly which is positioned between the first end and the second end of the plurality of wires; and
a casing coupled to the cable jacket and disposed around a second region of the assembly which is positioned proximate the second end of the plurality of wires; and
wherein the casing is at least partially removable by hand so as to expose the bare second segment of at least one of the plurality of wires.

14. The wire assembly of claim 13, wherein the assembly includes a third region which is positioned proximate the first end and the cable jacket is terminated such that the plurality of wires are unbundled and are not surrounded by the cable jacket in the third region.

15. The assembly of claim 13, further comprising a fan out kit coupled to the cable jacket and the plurality of wires are disposed in the fan out kit, wherein the fan out kit separates each of the plurality of wires from each other.

16. The assembly of claim 13, wherein the casing is made of a plurality of subsections and each subsection is individually removable.

17. The assembly of claim 13, wherein each of the plurality of wires is color coded.

18. The assembly of claim 13, wherein the casing is formed as a spiral structure.

19. The assembly of claim 13, wherein the casing is flexible to allow the assembly to bend along a central axis.

20. The assembly of claim 13, wherein at least one aperture is formed along the length of the casing to allow a portion of the bare second segment of at least one of the plurality of wires to be removed from withing the casing.

21. The assembly of claim 13, wherein the casing is secured to the cable jacket using adhesive.

22. The assembly of claim 13, wherein the casing is made from silicon.
